(19) United States
(12) Patent Application Publication
(10) Pub. No.: US 2018/0346055 A1
(43) Pub. Date: Dec. 6, 2018

(54) ADJUSTABLE PEDAL

(71) Applicant: Triumph Designs Limited, Leicestershire (GB)

(72) Inventor: Arvydas Jaselskis, Leicester (GB)

(21) Appl. No.: 15/995,390

(22) Filed: Jun. 1, 2018

(30) Foreign Application Priority Data
Jun. 2, 2017 (GB) 1708801.4

(51) Int. Cl. B62K 23/08; B62J 25/00; B62M 25/06

(52) U.S. Cl. CPC B62K 23/08; B60T 8/261; B62M 25/06; B62J 25/00

(57) ABSTRACT

An adjustable motorcycle pedal includes a member attached to the motorcycle and a peg attached to the member. The peg is moveable between a first position in which the peg extends from the member in a first direction and is anchored to the member in a manner suitable for a rider's foot to rest on the peg, and a second position in which the peg extends from the member in a second direction and is moveable to adjust the height of the peg relative to the member when the peg is returned to the first position.

### FIELD OF THE INVENTION

The present invention relates to an adjustable pedal for use on a motorcycle.

### BACKGROUND

Bike riders come in a variety of shapes and sizes. This means that ergonomics of any mass production bike may have to be compromised to suit more than one person. Dual purpose bikes may need to be compromised further to accommodate a variety of riding scenarios: on-road, off-road, off-road standing up, etc. Therefore, to satisfy multiple requirements, it is advantageous to utilise adjustable foot and hand controls. In this regard foot pedals may be considered to include brake pedals, gear change pedals or simple foot rests.

Typically motorcycle brake pedals comprise a lever pivotally attached to the motorcycle and a foot-peg (hereafter referred to just as a peg) attached to the lever, which is pushed down by the rider's foot to actuate the brake. FIG. 1 shows a lever 10 of a known brake pedal assembly. Lever 10 is pivotally mounted to a motorcycle (not shown) by way of a splined attachment 12. A peg 14 is mounted to the lever 10 at a position for enabling a rider to actuate the brake by pressing down on the peg 14. The peg 14 is fixed to the lever 10 at the position shown, and is not adjustable relative to the lever. Also shown in FIG. 1 is the position of a peg 14a that would be ideal for one mode of riding, and the position of another peg 14b at a position that would be ideal for another mode of riding. Accordingly the position of peg 14 is set so as to be a compromise between the two ideals, and is not itself ideal for either mode of riding. Similar compromises are often found with other foot pedals, e.g. gear change pedals or foot rests. A foot rest would typically be mounted to a member that is part of or rigidly attached to a motorcycle frame, rather than to a moveable lever.

Motorcycle pedals are known that have adjustable peg positions to vary the height and/or distance of the peg relative to the lever pivot. For example a rod connected to the lever may have an adjustable length. Similarly, a non-directly acting gear lever linkage length may be adjustable for changing peg height in relation to the rider's foot.

Alternatively, lever angle may be adjustable—for example a directly acting lever may be mounted on a splined shaft so as to be rotatable by one or more spline teeth to change peg height.

Broadly speaking, known adjustments may involve using tools—e.g. use of a slider to enable adjustment of distance between peg and lever pivot axis, or multiple pre-drilled holes to enable mounting of the peg at different locations on the lever, or use of an off-centre boss retained by a pinch bolt, which when slackened can be rotated to change height and/or distance between peg and lever pivot axis—or may be without use of tools—e.g. use of a pull and flip lever as a way of quickly adjusting lever height in relation to the ground, or use of a spring loaded peg having different offsets on opposing peg faces.

In addition, it is known to have folding components, in case they hit a stationary object. Folding foot-pegs are commonly employed on motorcycles. These have advantages over solid pedal assemblies, including a reduced likelihood of causing plastic deformation to the pedal, and a reduced impact load transferred through the pedal. Note that the peg assembly must not fold in the same direction as it is pressed to operate a brake or gear change.

However, a problem arises when trying to provide more than one of the above functions on a single pedal, without increasing assembly and material costs.

The present invention has been conceived with the foregoing in mind.

### SUMMARY

According to the present invention there is provided an adjustable motorcycle pedal, comprising: a member attached to the motorcycle; and a peg attached to the member. The peg is moveable between a first position in which the peg extends from the member in a first direction and is anchored to the member in a manner suitable for a rider's foot to rest on the peg, and a second position in which the peg extends from the member in a second direction and is moveable to adjust the height of the peg relative to the member when the peg is returned to the first position.

In embodiments the peg height is adjustable by rotation of the peg.

It is an advantage that the motorcycle pedal combines the functions of a folding peg design and an adjustable peg height. In addition, the peg height can be quickly and easily adjusted without the use of tools by means of a simple rotation of the peg.

The pedal may be used to actuate a control function and the member may be a lever configured to be moved by the rider's foot to actuate the control function. The pedal may be a brake pedal. The pedal may be a gear change pedal. Alternatively, the pedal may be a foot rest.

The peg may be moveable between the first position and the second position by pivotal movement of the peg relative to the member. The peg may be attached to the member through an aperture, the aperture being shaped to allow the peg to be pivoted to move from the first position to the second position. The peg may be attached by a pivot bolt that extends through the aperture, the bolt having a bolt axis, and the aperture being shaped to permit pivotal movement of the bolt about an axis perpendicular to the bolt axis for moving the peg between the first and second positions, rotational movement of the bolt about the bolt axis facilitating adjustment of the height of the peg.

The member may further comprise a keyway adjacent to the aperture, the keyway receiving a protrusion attached to the peg, and wherein the keyway is shaped to prevent rotation of the peg when the peg is in the first position and to allow rotation of the peg when the peg is in the second position.

It is an advantage that the use of the keyway and anti-rotation block ensures that the peg can only be adjusted (rotated) when it is in the second position. This also ensures that the pedal performs like a solid lever and peg pedal during normal operating conditions.

The second direction may be at an angle to the first direction of between 20° and 70°, or preferably at an angle of between 30° and 60°, more preferably at an angle of between 40° and 50°, and most preferably at an angle of 45°.

Preferably movement of the peg from the first position to the second position is in a different direction to movement of the lever to actuate the control function.

The adjustable brake pedal may further comprise a spring urging the peg into the first position. It is an advantage that the spring maintains the peg firmly pressed into its normal position.

### BRIEF DESCRIPTION OF THE DRAWINGS

FIG. 1 shows a known brake pedal lever with different positions for a foot-peg.

FIGS. 2a and 2b show part of a brake pedal lever with an attached peg with adjustable height in accordance with an embodiment.

FIG. 3 shows a cross-section through the peg of FIGS. 2a and 2b.

FIG. 4 shows the part of the brake pedal lever with attached peg of FIGS. 2a and 2b, with the peg in a folded position.

FIG. 5 shows detail of an aperture receiving a bolt for attaching the peg to the brake pedal lever of the embodiment of FIGS. 2a, 2b, 3 and 4.

FIG. 6 shows part of the lever and aperture of FIG. 5, without an attached peg and showing an associated keyway.

FIG. 7 shows an anti-rotation block forming part of the brake pedal embodiment of FIGS. 2a, 2b and 3 to 6.

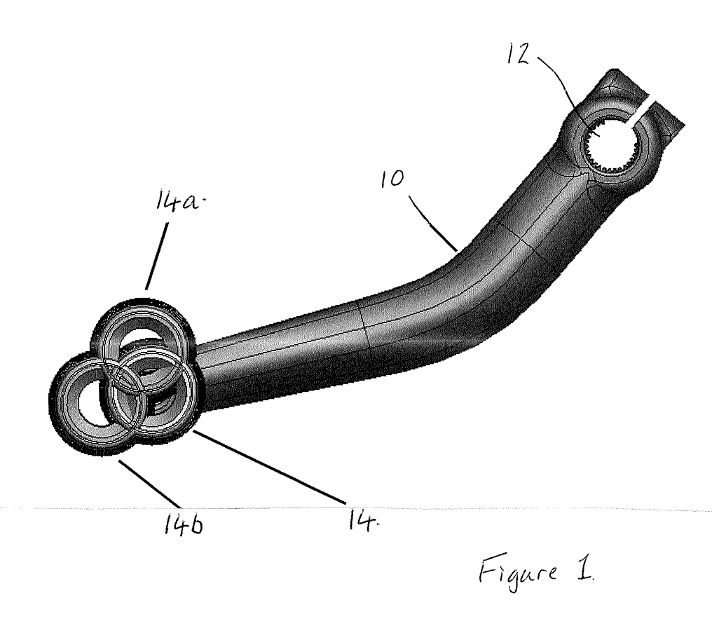

### DETAILED DESCRIPTION

The embodiments described below are in relation to a brake pedal. However, it should be appreciated that the principles described may be employed in relation to any motorcycle foot pedal, including, but not necessarily limited to brake pedals, gear change pedals or foot rests.

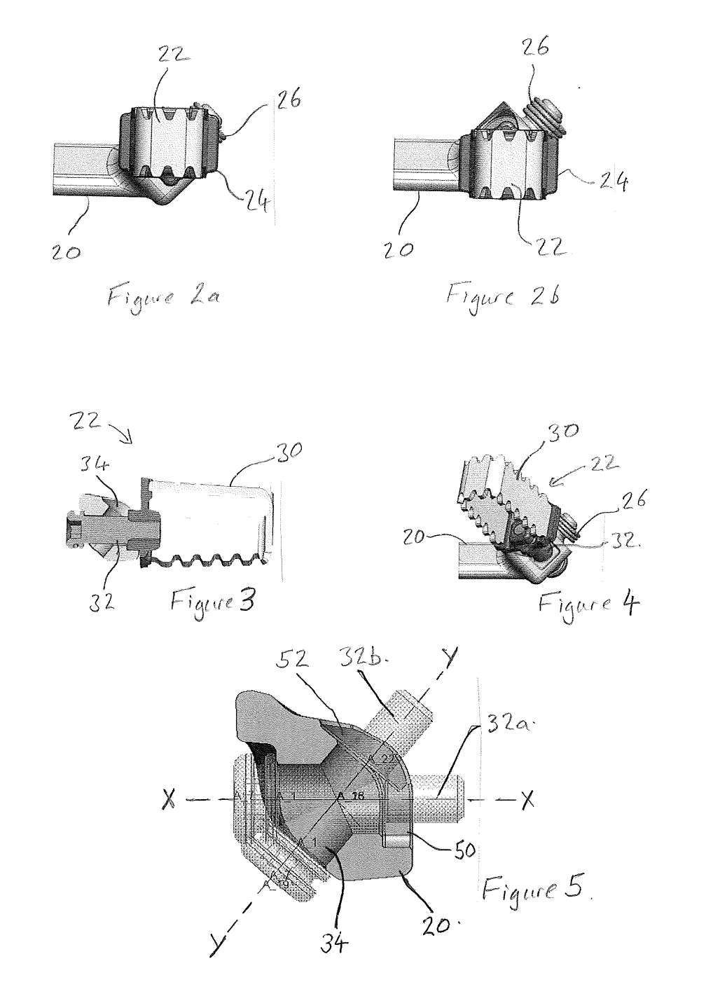

Referring to FIGS. 2a and 2b, FIG. 2a shows part of a brake pedal assembly in accordance with an embodiment of the invention, with a lever 20 having a foot-peg 22 mounted in a first, higher position relative to the lever 20. FIG. 2b shows the same part of the brake pedal assembly as FIG. 2a, but with the peg 22 mounted at a second, lower position. As will be described further below, the position of the peg 22 can be changed quickly and without use of tools by means of a gripping and flipping action. As shown in FIGS. 2a and 2b, the peg 22 extends substantially perpendicular to the lever 20 (i.e. out of the page), in what will be referred to as the first or normal position of the peg.

Also partially visible in FIGS. 2a and 2b are an anti-rotation block 24 and a spring 26.

FIG. 3 shows a cross-section of the peg 22 of FIGS. 2a and 2b. The peg 22 includes a U-shaped castellated strip 30 (typically formed of a metal such as steel), which is attached to and extends from a cylindrical bolt portion 32. The bolt portion 32 is attached at a position such that one side of the castellated strip 30 is further from the axis of the bolt 32 than the other side. The cylindrical bolt portion 32 passes through a shaped aperture 34 in a part of the lever 20. The shaped aperture 34 allows the bolt 32 to pivot through an angle relative to the lever 20. This is shown in FIG. 4 with the peg 22 folded back at an angle to the lever 20. In the depicted embodiment the angle is about 45°. In this folded, or second, position, the peg 22 can be rotated about the axis of the bolt. Rotation of the peg 22 through 180° and then returning the peg to the first or normal position will mean that the top and bottom surfaces of the peg 20 have been reversed so as to change the height of the peg (i.e. to change from the position shown in FIG. 2a to that of FIG. 2b, or vice versa). It will be appreciated that the angle between the peg and the lever when the peg is folded need not be 45° but may be any suitable angle such as any angle between 20° and 70°, or preferably between 30° and 60° degrees, more preferably between 40° and 50°.

The spring 26 shown in FIGS. 2a, 2b and 4 urges the peg 22 into the first, normal position. Accordingly, to change the height of the peg 22 relative to the lever 20, a user simply pushes the peg against the action of the spring into the second, folded position, rotates the peg through 180° and releases it so that the spring urges the peg 22 back to the normal position but with its top and bottom surfaces reversed.

It will be appreciated that the peg 22 is adjustable to two different heights, but that pegs may be provided that have more than two heights. For example a peg may have a triangular shape with three surfaces each at a different spacing from the bolt axis, and such that the peg may be rotated through two different angles to obtain a total of three different peg heights. The same principle may be extended to pegs having four or more different heights.

FIG. 5 shows more detail of the aperture 34 in the lever 20 and shows the bolt portion 32 of the peg 22 in each of the two positions—first or normal position 32a and second or folded position 32b. In the first position of the bolt 32a, it extends along an axis X-X, while in the second position of the bolt 32b it extends along axis Y-Y at an angle (e.g. 45°) to axis X-X. The shape of the aperture 34 allows the bolt 32 to pivot around an axis orthogonal to the axes X-X and Y-Y intersecting them at the point where the axes cross. Also shown in FIG. 5 is the profile of a keyway 50, 52 formed as a recess in a surface of the lever 20. The keyway has a first part 50 adjacent to the axis X-X of the bolt in the first position 32a, and a second part 52 adjacent to the axis Y-Y of the bolt in the second position 32b.

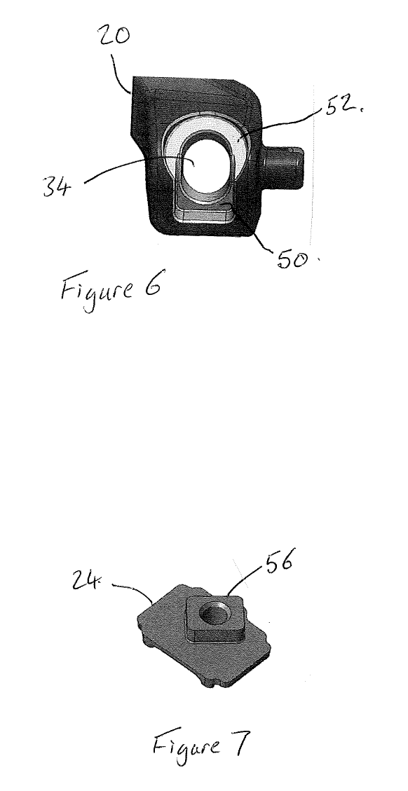

FIG. 6 shows the keyway 50, 52 looking towards the aperture 34 in the lever 20 from the direction of the peg 22, but without the peg being present. The first part 50 of the keyway has a parallel-sided, or rectangular shape, while the second part 52 has a circular shape. The reason for this will be apparent from FIG. 7, which shows the anti-rotation block 24 that is fixed to the peg 22, as shown in FIGS. 2a and 2b. The anti-rotation block 24 has a square (or rectangular) protrusion 56 sized to fit into the first, parallel-sided part of the keyway 50, when the peg 22 is in the first position. In this position the peg 22 cannot be rotated due to the presence of the protrusion 56 in the keyway 50. However, when the peg 22 is moved to the second position, such that the axis of the bolt 32 extends through the aperture 34 adjacent to the second part of the keyway 52, the circular shape of the second part of the keyway 52 no longer prevents the protrusion 56 from being rotated and so the peg 20 can be rotated to allow adjustment of the peg height as described above.

It will be apparent from the above that the brake pedal described provides numerous advantages over prior art designs. In particular the brake pedal combines the functions of a folding peg design and an adjustable peg height. In addition, the peg height can be quickly and easily adjusted without the use of tools by means of a simple flipping grip action. The use of the keyway and anti-rotation block ensures that the peg can only be adjusted (flipped) when it is in the maximum fold-up position. This also ensures that the lever performs like a solid lever and peg pedal during normal operating conditions and while the spring maintains the peg firmly pressed into its normal position. All of the above advantages may also apply to other types of motorcycle pedal, including gear change pedals and foot rests.

1. An adjustable motorcycle pedal, comprising:
a member attached to the motorcycle: and
a peg attached to the member,
wherein the peg is moveable between a first position in which the peg extends from the member in a first direction and is anchored to the member in a manner suitable for a rider's foot to rest on the peg, and a second position in which the peg extends from the member in a second direction and is moveable to adjust the height of the peg relative to the member when the peg is returned to the first position.

2. The adjustable motorcycle pedal of claim 1, wherein the peg height is adjustable by rotation of the peg.

3. The adjustable motorcycle pedal of claim 1, wherein the pedal is used to actuate a control function and the member is a lever configured to be moved by the rider's foot to actuate the control function.

4. The adjustable motorcycle pedal of claim 3, wherein the pedal is a brake pedal.

5. The adjustable motorcycle pedal of claim 3 wherein the pedal is a gear change pedal.

6. The adjustable motorcycle pedal of claim 1 wherein the pedal is a foot rest.

7. The adjustable motorcycle pedal of claim 1 wherein the peg is moveable between the first position and the second position by pivotal movement of the peg relative to the member.

8. The adjustable motorcycle pedal of claim 7, wherein the peg is attached to the member through an aperture, the aperture being shaped to allow the peg to be pivoted to move from the first position to the second position.

9. The adjustable motorcycle pedal of claim 8, wherein the peg is attached by a pivot bolt that extends through the aperture, the bolt having a bolt axis, and the aperture is shaped to permit pivotal movement of the bolt about an axis perpendicular to the bolt axis for moving the peg between the first and second positions, rotational movement of the bolt about the bolt axis facilitating adjustment of the height of the peg.

10. The adjustable motorcycle pedal of claim 2, wherein the lever comprises a keyway adjacent to the aperture, the keyway receiving a protrusion attached to the peg, and wherein the keyway is shaped to prevent rotation of the peg when the peg is in the first position and to allow rotation of the peg when the peg is in the second position.

11. The adjustable motorcycle pedal of claim 1, wherein the second direction is at an angle to the first direction of between 20 and 70 degrees, preferably at an angle of between 30 and 60 degrees, more preferably at an angle of between 40 and 50 degrees, and most preferably at an angle of 45 degrees.

12. The adjustable motorcycle pedal of claim 3, wherein movement of the peg from the first position to the second position is in a different direction to movement of the lever to actuate the control function.

13. The adjustable motorcycle pedal of claim 1, further comprising a spring urging the peg into the first position.
